(19) United States
(12) Patent Application Publication
(10) Pub. No.: US 2014/0330968 A1
(43) Pub. Date: Nov. 6, 2014

(54) METHOD AND TREND ANALYZER FOR ANALYZING DATA IN A COMMUNICATION NETWORK

(71) Applicants: Jawad Mohamed Zahoor, Chennai (IN); Azadeh Bararsani, Serris (FR); Mona Matti, Nacka (SE); Tor Kvernvik, Taby (SE)

(72) Inventors: Jawad Mohamed Zahoor, Chennai (IN); Azadeh Bararsani, Serris (FR); Mona Matti, Nacka (SE); Tor Kvernvik, Taby (SE)

(73) Assignee: Telefonaktiebolaget L M Ericsson (publ), Stockholm (SE)

(21) Appl. No.: 14/365,050

(22) PCT Filed: Dec. 15, 2011
(86) PCT No.: PCT/SE2011/051518

§ 371 Date: Jun. 12, 2014

(51) Int. Cl. H04L 12/26; G06Q 30/02; G06F 17/30; H04L 29/08

(52) U.S. Cl. CPC H04L 43/08; H04L 67/22; G06Q 30/0201; G06F 17/30539
USPC 709/224

(57) ABSTRACT

A method and apparatus for performing analysis of client related data obtained from a communication network. A trend analyzer analyzes a trend of a client segment, which trend has been detected by a data stream analysis of the client related data. The trend reflects a change over time of at least one feature derived from the client related data. The trend analyzer then requests a batch based deep analysis when the trend fulfils a trigger condition, to find a cause for the trend. A result of the deep analysis is then provided to a result consumer. Thereby, the deep analysis may be performed only when a trend has been detected thus being more responsive to trends by the stream analysis and reguiring less resources, as compared to when data is always subjected to deep analysis regardless of whether a trend occurs or not.

### TECHNICAL FIELD

The present disclosure relates generally to a method and a trend analyzer that can be used for analyzing data generated for users and devices in a communication network and gaining knowledge from any trends that can be detected in the analyzed data.

### BACKGROUND

In the field of telecommunication, data mining is employed to obtain knowledge on various aspects of subscribers, users, terminals, devices or sensors in a communication network, which in the following description will be collectively referred to as “clients” for short. For example, solutions have been devised for identifying and offering services and products that are relevant and attractive to different device users according to their interests and needs in different situations. Thereby, the users will be better served by receiving relevant and interesting offerings and not irrelevant ones, which could increase their general responsiveness to such offerings. Another area of interest is using so-called “M2M” (Machine-to-Machine) devices such as sensors to provide measurements and observations to a central function for monitoring or controlling a process or environment.

There are also solutions for analyzing users in a telecommunication network to identify segments of users, also referred to as “clusters”, having common characteristics in some sense, e.g. to provide service or product offerings to users in a specific segment jointly. This analysis work is typically made on traffic data generated by communication nodes in the network which is stored as Call Detail Records (CDR) in a Charging data Reporting System (CRS) or the like. Traffic data can also be obtained by means of various traffic analyzing devices, such as Deep Packet Inspection (DPI) units and other traffic detecting devices, which can be installed at various nodes in the network.

The traffic data that can be collected and analyzed may refer to various communication sessions involving voice calls, messages, downloadings, web browsing, e-mails, on-line games, etc., and may include information such as type of service, duration, data amount, time of day and location, successful or failed, and so forth. This kind of information can thus be used to analyze the clients for different purposes and aspects. For example, Machine Learning Algorithms (MLAs) can be used for processing the traffic data to extract useful information therefrom.

FIG. 1 illustrates an example of how data mining can be employed for a communication network 100 to enable relevant and adapted services to subscribers from service providers 106. A Data Mining Engine (DME) 104 typically uses one or more MLAs 104a for processing traffic data “TD” provided from a data source 102, and further for analysis to identify client segments and dusters. For example, CDR information and other traffic related data generated in the network 100 is registered in the data source 102 from which the traffic data TD is provided to the DME 104. Other information sources from the network operator may also be used by the DME 104 in this context, such as network alarms, performance measurements, demographic user data, and so forth. After processing the traffic data and identifying segments, the DME 104 provides the resulting segment information as output data to the service providers 106 to enable adapted services and targeted marketing activities for the identified segments.

In data mining, there are two basic approaches available for analyzing client related data obtained from a communication network, known as batch analysis and stream analysis which are schematically illustrated in FIG. 2. In batch analysis, the data generated in the network 200 is first collected over time in a data storage, here denoted data collector 202. When a sufficient amount of data has been collected over an extended time period to provide a useful basis for the analysis, e.g. of a predefined set or segment of clients, the collected data is transferred in a typically huge batch of data to a batch analyzer 204 which then performs the actual analysis on the data requiring typically great amounts of resources therein. In the future, the amount of data generated in communication networks will surely grow even more due to increased service usage. When the analysis is completed after extended processing, often referred to as a “job”, a result can be delivered in an intermittent manner to a “result consumer” 208, which term is used to represent any party or application in need of the analysis result for whatever reason.

In the alternative approach of stream analysis, a stream analyzer 206 receives a continuous stream of data from the network 200 basically in real-time as soon as the data is generated. Having typically no resources suitable for handling great data amounts, as compared to the batch analyzer 204, the stream to analyzer 206 can only analyze data in small portions, i.e. generated in a much shorter time span, often using the technique known as “sliding windows”, and can also deliver results of the analysis more or less in a continuous manner, hence the term “real-time results”.

The sliding windows technique means that a small chunk of data generated during a window of limited time span, e.g. a few seconds, is processed and the window is moved forwards a certain small portion of time to provide the next chunk of data for processing in an overlapping fashion, i.e. a next time window starts before the previous time window has ended. When data from one time period has been analyzed, the data of that period is discarded and a new set of data is obtained and analyzed in the next time period or window. As a result, the stream analyzer 206 can generally only make a quite rudimentary analysis, e.g. to basically recognize what has happened, while the batch analyzer 204 is capable of making a more advanced analysis of data from a longer time span, e.g. to basically recognize why it has happened.

When the batch approach is employed in practice, the amount of data in the batch is typically quite large containing data that has been generated in the network 200 over en extensive time period, e.g. in the range of several days, weeks or months, in contrast to the smaller data amounts and shorter time spans of stream analysis. This is deemed necessary in order to make an intelligent analysis in the batch approach, e.g. to discover occurrences of fraud, revenue leakage or chum of subscribers in the network, or to notice and understand an abnormal situation in a monitored process or environment that needs attention and actions. Consequently, substantial processing resources are required to cater for all the data in a data batch and the analysis should preferably be done for batch after batch to cover all data generated in the network, at least for a predefined set of clients, and to discover whenever some change of situation occurs that needs attention. In this approach, the processing resources are used and occupied for analysis of all data batches, i.e. also when no change of situation occurs which could be most of the time. Further, it is not possible to discover that a change occurs in real time, as in stream analysis, since the data must first be collected over an extended time period before the analysis is made.

The alternative approach of stream analysis requires a smaller amount of resources and is more responsive to changes causing less delay due to the shorter time span of the sliding windows technique, typically a few seconds. However, this analysis method is not capable of making more advanced analysis, e.g. like the above batch analysis, due to the limited amount of resources and the short time span analyzed at a time, e.g. to analyze and establish the cause for a change of situation that has occurred.

### SUMMARY

It is an object of the invention to address at least some of the problems and issues outlined above. It is possible to achieve these objects and others by using a method and an apparatus as defined in the attached independent claims.

According to one aspect, a method is provided in a data analyzing system for performing analysis of client related data obtained from a communication network. In this method, a trend of a client segment detected by means of a data stream analysis of the client related data, is analyzed. The trend reflects a change over time of at least one feature related to the client segment and derived from the client related data. When the trend fulfils a trigger condition, a deep analysis is requested, e.g. from a batch analyzer, to find a cause for the trend by means of batch based analysis of the client related data pertaining to the client segment. A result of the requested deep analysis indicating the cause, is then provided to a result consumer.

According to another aspect, a trend analyzer is provided in a data analyzing system configured to perform analysis of client related data obtained from a communication network. The trend analyzer comprises a logic unit adapted to analyze a trend of a client segment detected by means of a data stream analysis of the client related data. The trend reflects a change over time of at least one feature related to the client segment and derived from the client related data, and to determine if the trend fulfils a trigger condition. The trend analyzer also comprises a requesting unit adapted to request a deep analysis when the trend fulfils the trigger condition, to find a cause for the trend by means of batch based analysis of the client related data pertaining to the client segment, such that a result of the requested deep analysis indicating the cause can be provided to a result consumer.

The above method and apparatus may be configured and implemented according to different optional embodiments. In one possible embodiment, a stream filter is applied to the client related data before the data stream analysis for extracting data related to a limited set of clients. The stream filter may be initially configured to extract data related to a default set of clients. The stream filter may further be adjusted to refine the client segment, based on the outcome from any of: the analyzing of the segment trend and the analyzing of the deep analysis, such that data related to the refined client segment is extracted by the stream filter.

In further possible embodiments, the trigger condition may dictate that the deep analysis is requested when the change over time of at least one feature exceeds a prescribed limit. The at least one feature may refer to any of: the amount of executed calls and sessions, the time of day, week or season of executed calls and sessions, the amount of failed calls and sessions, and a measured sensor parameter. The client related data may pertain to any of: subscribers in the communication network, communication devices and sensors. The result consumer may be any of: a network operator, a service provider, and an application for monitoring or controlling a process or an environment.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1 is a communication scenario illustrating analysis of data from a communication network, according to the prior art.

FIG. 2 is a communication scenario illustrating two common available approaches for analysis of data, according to the prior art.

FIG. 3 is a communication scenario illustrating how client related data can be analyzed in an efficient way, according to some possible embodiments.

FIG. 4 is a flow chart illustrating a procedure in a data analyzing system comprising a trend analyzer, according to further possible embodiments.

FIG. 5 is a flow chart illustrating a more detailed procedure in a data analyzing system comprising a trend analyzer, according to further possible embodiments.

FIG. 6 is a signalling diagram illustrating an example of a procedure when the solution is used, according to further possible embodiments.

FIG. 7 is a block diagram illustrating in more detail a data analyzing system comprising a trend analyzer, according to further possible embodiments.

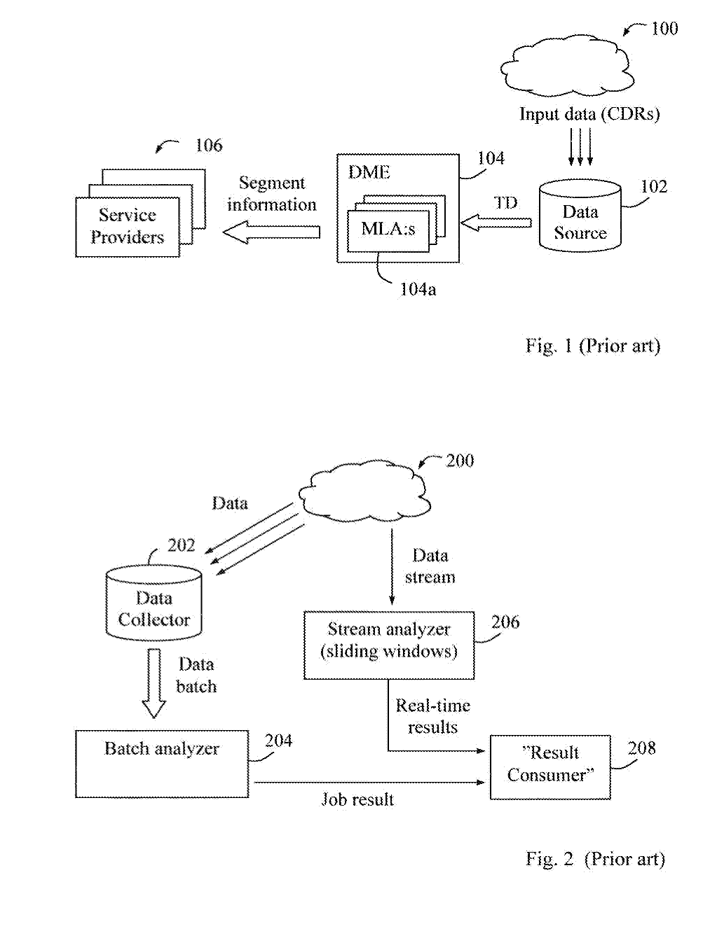

### DETAILED DESCRIPTION

Briefly described, a solution is provided that can be used to improve the process of finding the cause for a trend in a communication network, e.g. in terms of efficiency, usage of resources, accuracy, reliability and delays. The trend may be pertinent for any type of client segment, e.g. a group of subscribers of a certain category or in a certain geographical area, or a group of devices or sensors of a certain type or location, and so forth. The trend of interest may be caused by fraud, revenue leakage or chum of subscribers, or by an abnormal situation in a monitored process or environment that needs attention and actions. It is assumed in this description that if the change causing the trend is sufficiently significant, it is generally of interest to establish the cause for this trend, e.g. in order to take any necessary action of remedy or caution.

In this solution, the above-described functions of stream analysis and to batch analysis are combined and coordinated, by means of a new function termed “trend analyzer”, in a way that can reduce the need for processing resources yet being accurately responsive to changes and trends without much delay and that may need attention and/or actions. The trend analyzer receives information regarding a trend of a client segment which has been detected by a stream analyzer from a received stream of client related data, e.g. using sliding windows, which “trend” thus indicates that at least one feature related to the client segment and derived from the client related data has changed in some way, which can be discovered by the sliding windows technique, i.e. virtually in real time. Using the stream analyzer for trend detection has the advantage that the trend can be detected as soon as it appears and without requiring huge amounts of resources for processing and analyzing the incoming data, particularly if sliding windows with a relatively short time span are used.

The trend analyzer then evaluates whether the trend fulfils a prescribed trigger condition dictating that when the change is sufficiently significant, a deep analysis over a relatively larger time span and using more data sources, is warranted. In that case, the trend analyzer accordingly sends a request for a deep analysis of the client segment to a batch analyzer, to find a cause for the trend by means of data batch analysis of the client related data pertaining to that client segment, which may include data from sources not used in the stream analysis.

Using the batch analyzer in this way for establishing the cause has the advantage that the processing resources available therein are needed and used only when the trend is detected but not otherwise, which is a more efficient use of the resources as compared to when the incoming data is subjected to deep analysis at all times even when no trends occur. Thereby, the benefits of both stream and batch analysis can be utilized in an efficient manner. The features and potential benefits of this solution will be explained below when describing some possible examples of useful embodiments.

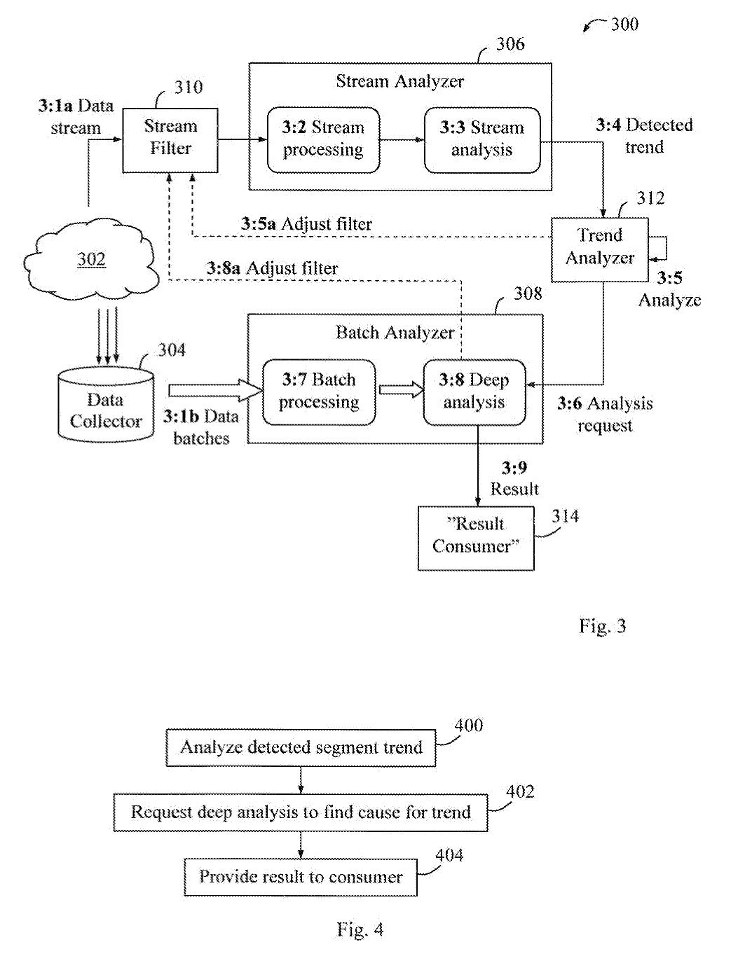

An example of how analysis of client related data obtained from a communication network can be performed by using the above solution, will now be described with reference to the communication scenario shown in FIG. 3. This procedure is performed by a data analyzing system 300 on the basis of client related data generated in a communication network 302, which could be any type of network such as a cellular network for wireless communication or a fixed network, and the solution is basically not limited to any particular types of communication networks. For example, the client related data may pertain to any of: subscribers in the communication network, communication devices and sensors.

The data generated in network 302 may refer to various communication sessions executed in the network. The data may further refer to measurements and observations being reported from sensors to a central function for monitoring or controlling a process or environment. Further data that can be used in this solution may come from network alarms, performance measurements, demographic user data, and so forth. This solution is basically not limited to any particular types of data coming from the network 302. In this solution, the data from network 302 is both collected in a data collector 304 for batch analysis in a batch analyzer 308 and supplied as a data stream for steam analysis in a stream analyzer 306, as schematically indicated by arrows from network 302 downwards and upwards, respectively.

This scenario also involves a result consumer 314 that is assumed to have interest in whether any significant trends occur in the network and the cause for such a trend, in order to notice and understand such trends and possibly take any necessary action. The result consumer 314 may be a network operator, a service provider, a control application, a surveillance system, and so forth. For example, a trend in the analyzed data may indicate occurrences of fraud, revenue leakage or chum of subscribers in the network, or an abnormal situation in a monitored process or environment that needs attention and actions. A trend may also refer to situations in the network such as traffic load, congestion, faults in software and/or network equipment, etc. The procedure below can provide useful information to the result consumer 314 regarding such trends whenever they occur, as explained below, and may be performed e.g. when triggered by a request, not shown, from the result consumer 314 or on a regular basis according to a subscription or the like.

In the shown process, an action 3:1a indicates that the stream of data generated in network 302 is supplied to the stream analyzer 306 and may first pass through a stream filter 310 to limit the amount of received data to a particular client segment of interest, which will be explained later below. At the same time, the same data and possibly other data is also collected from network 302 by data collector 304, as indicated by multiple arrows from network 302. Another action 3:1b indicates that data batches of suitable size are supplied from data collector 304 to the batch analyzer 308, e.g. on a regular basis such as once a day or once a week, etc., in order to be analyzed by batch analyzer 308. Actions 3:1a and 3:1b are thus basically executed in parallel, more or less.

Although the data collector 304 is shown as a separate entity connected to the batch analyzer 308, the data collector may in practice be integrated as a part of the batch analyzer 308. Similarly, the stream filter 310 may in practice be integrated as a part of the stream analyzer 306.

The stream analyzer 306 basically operates to detect any trends of changes that may occur in the network for the relevant client segment, which trend would somehow be reflected in the received data stream. Thus, the filtered data stream may be initially processed by the stream analyzer 306 in an action 3:2, which may include various calculations, transformations and compilations of raw data in the stream, in preparation for the actual analysis which is performed by stream analyzer 306 in a next shown action 3:3.

It should be noted that actions 3:1-3:3 will be executed in a continuous manner for the data in the received stream, e.g. by using the sliding windows technique where small chunks of data, e.g. generated during a few seconds, are processed one after another. For example, the sliding windows may be used in an overlapping fashion, i.e. a next time window starts before the previous window has ended. In this part of the process, any changes and trends can be detected by comparing the results obtained for successive time windows or periods.

The stream analysis is thus made in view of discovering whether any unexpected or abnormal trend occurs in the data of the received stream with respect to one or more features, e.g. according to a predefined model. A set of such models may thus have been predefined where each model is represented by a vector comprising one or more client related features that can be measured from the generated client data. The above one or more features may, without limitation, refer to any of: the amount of executed calls and sessions, the time of day, week or season of executed calls and sessions, the amount of failed calls and sessions, and a measured sensor parameter. Certain variations of these features may be normal and expected and trends with such variations can be ignored without needing special attention or actions. The stream analyzer 306 may be adapted to learn and recognize such normal trends.

For example, if a set of sensors are the “clients” in this context, the features in such a model may include a parameter measured by the sensors that may start to deviate from a regular pattern, hence an abnormal or unexpected trend. In another example, a feature may be the number of failed calls or sessions for a segment of subscribers which may fail to an increasing extent, e.g. in the form of dropped voice calls, creating another trend. In yet another example, two features of a monitored model may be the extent of executed Internet sessions and voice calls, respectively, and the subscribers may change their behaviour and do more Internet browsing and less phone calls which can be detected as an abnormal or unexpected trend by monitoring the generated data according to that model, and so forth.

This kind of changes and others may thus be detected by the stream analyzer 306 which requires relatively small processing capacity since only a relatively small amount of data is analyzed at a time and then thrown away, e.g. using the sliding windows technique, in contrast to the batch analyzing technique described above. Still, whenever a change occurs that indicates a trend, it can be detected without much delay since the stream analyzer 306 does not have to wait very long before the analysis work of each data chunk can start. As a result, the stream analysis can be regarded to be more or less continuous in this context and rapidly responsive to trends. A plurality of predefined models may further be to evaluated continually in parallel by the stream analyzer 306 to detect a trend in any of the models. Each model may be identified by a Model identification, MID.

During the above stream analysis process, the same data and possibly other data is also collected from network 302 by data collector 304, as indicated by multiple arrows from network 302. Once a trend is detected by stream analyzer is 306 in actions 3:1-3:3, e.g. according to any of the monitored models, a notification of the detected trend and corresponding model is supplied to the trend analyzer 312, in another action 3:4. In this context, the term “trend” implies a noteworthy change over time of at least one feature related to the client segment of interest, e.g. according to a predefined model as described above, and derived from the client related data. The trend analyzer 312 may receive the MID of the model of the detected trend from stream analyzer 306, and select that model from a set of predefined models for identifying the one or more features.

In this solution, the trend analyzer 312 then checks in a next action 3:5 whether the trend detected and indicated by stream analyzer 306 fulfils the prescribed trigger condition. Basically, the trigger condition dictates that a batch-based deep analysis is warranted when the change over time of at least one feature exceeds a prescribed limit, to find a cause for the trend by means of data batch analysis. In this check, the model indicated by the stream analyzer 306, e.g. by the MID, is applied which comprises a vector with the one or more features that can be measured from the received client related data. To this end, the trend analyzer 312 may hold different trigger conditions and different corresponding models, and thus checks if the trigger condition of the indicated model is fulfilled or not with respect to the one or more features of that model.

Further, the trend analyzer may also adjust the stream filter 310, in an optional action 3:5a, based on the detected trend to refine the selection of data entering the stream analyzer 306. For example, the stream filter may be initially configured to extract data related to a default set of clients, and the stream filter may then be adjusted to refine the client segment based on results from the analyzing of the detected trend, such that more relevant data related to the refined client segment is extracted by the stream filter.

If the above trigger condition is found to be fulfilled by the analyzed data and detected trend in action 3.5, the trend analyzer 312 sends a request for a deep analysis to the batch analyzer 308, as shown in a further action 3:6, to find a cause for the trend by means of data batch analysis of the client related data which has been collected in data collector over some considerable time before the trend detection. To mention a few examples, the request for deep analysis may comprise any of: a Trend identification, TID, a Request identification RID, the MID of the model for which the trend was detected, and some suitable indication of which clients or which client segment to be subjected to the deep analysis. Further, the trend analyzer 312 may evaluate a series of different detected trends and may maintain a mapping table for the TID of the detected trends and their corresponding RIDs and MIDs.

As indicated by action 3:1b, one or more data batches have been supplied to the batch analyzer 308 which may be done at any time before or during the stream analysis and trend analysis of actions 3:1-3:6. Thus, it can be assumed that once the request for deep analysis is received in action 3:6, the data to be subjected to the deep analysis has already been collected, more or less, by data collector 304 and supplied to batch analyzer 308.

The received batch or batches of data are processed in an action 3:7 in preparation for the deep analysis to be performed. Processing the data batch(es) may involve selection of data that is relevant to the detected trend and/or the client segment that was subject to the stream analysis, e.g. based on the client segment indication and/or MID in the received request. For example, it may be sufficient to analyze only data relating to the features in the vector of a model for which the trend was detected. In other examples, it may be necessary and/or suitable to also analyze other data in addition to the features in the model vector.

The deep analysis is then performed on the processed data, in an action 3:8, basically in order to determine the cause for the trend. It should be noted that the deep analysis is more profound than the above-described stream analysis and covers a much greater amount of data generated during a substantially longer time period than the chunks of data analyzed by stream analyzer 306. To this end, more sophisticated and powerful processing resources are used and the deep analysis also takes some more time to complete even though substantially all data is already available from the data collector 304. Further, the batch analyzer may also adjust the stream filter 310, in an optional action 3:8a, based on the outcome of the deep analysis. For example, the stream filter may then be adjusted to further refine the client segment, such that data that is particularly interesting in view of a determined potential cause for the trend is extracted by the stream filter 310.

The process of actions 3:1a,b-3:8, 3:8a may be repeated in an iterative manner, e.g. refining the stream filter based on ongoing analysis of 3:5 and 3:8, until the outcome of the deep analysis of 3:8 is stabilized and finished. A final result of the deep analysis indicating the detected trend and the cause therefor, can then be delivered in a suitable manner to the result consumer 314, in a final shown action 3:9. In a simple example, a trend of unwanted fluctuating temperature may have been detected in a storage room, and the cause found may be that a central air condition system is faulty since a similar pattern of fluctuating temperature has also been detected in other rooms controlled by the same air condition system.

A procedure in data analyzing system, such as system 300 above, for performing analysis of client related data obtained from a communication network, will now be described with reference to the flow chart in FIG. 4, illustrating actions executed in the data analyzing system which comprises at least a stream analyzer, a batch analyzer and a trend analyzer. The procedure illustrated in FIG. 4 is thus directed to how the data analyzing system can operate, and the stream analyzer 306, batch analyzer 308 and rend analyzer 312 described for FIG. 3 may be used also in the procedure of FIG. 4.

A first action 400 illustrates that the data analyzing system analyzes a trend of a detected client segment by means of a data stream analysis of the client related data, which trend reflects a change over time of at least one feature related to the client segment and derived from the client related data. This action basically corresponds to action 3:5 above. A next action 402 illustrates that a deep analysis is requested when the trend fulfils a trigger condition, to find a cause for the trend by means of batch based analysis of the client related data pertaining to the client segment. This action basically corresponds to action 3:6 above. A final action 404 then illustrates that the data analyzing system provides a result of the requested deep analysis indicating the cause, to a result consumer, basically corresponding to action 3:9 above.

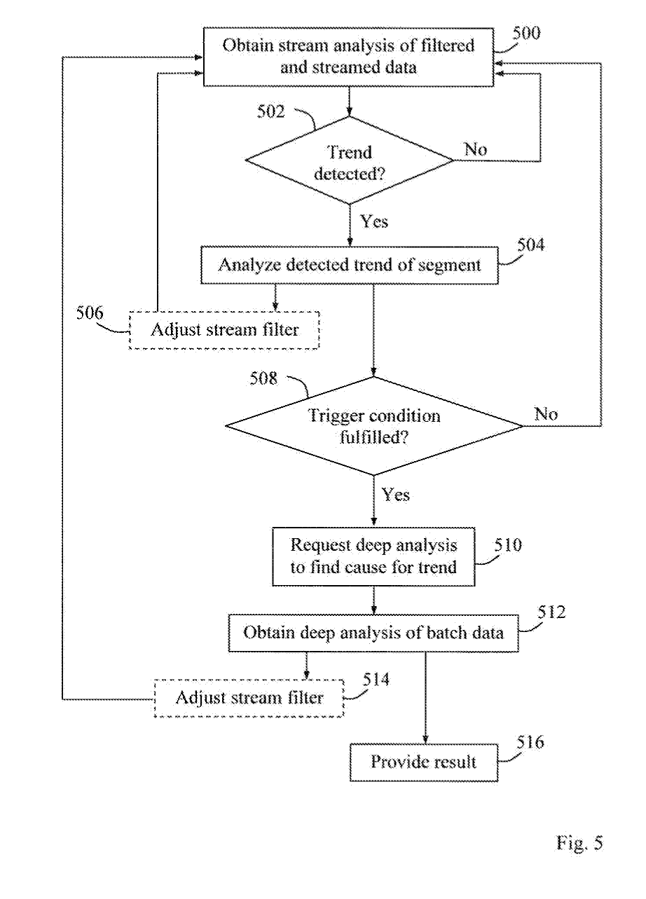

A more detailed example of a procedure in data analyzing system, for performing analysis of client related data obtained from a communication network, will now be described with reference to the flow chart in FIG. 5. This example likewise illustrates actions executed in the data analyzing system which comprises a stream analyzer, a batch analyzer and a trend analyzer. A stream filter is also used in this example, such as the above filter 310. A first action 500 illustrates that a stream analysis of filtered and streamed data of a client segment of interest is obtained which has been executed by the stream analyzer. As mentioned above in a previous example, the stream filter may initially have a default setting such that it is configured to extract data related to a default set of clients including the client segment of interest. The filter may be adjusted to refine the client segment later on in the process, to be described below.

It is then determined if a trend is detected from the executed stream analysis, in an action 502. If not, the stream analysis of action 500 will continue until a trend can be detected in action 502. In that case, the detected trend of the client segment is analyzed by the trend analyzer, in an action 504, in view of finding out whether a deep analysis is warranted for the client segment. The trend analysis may trigger adjustment of the stream filter, in an optional action 506, e.g. to further refine the client segment and to extract more relevant data pertaining to a discovered potential cause for the detected trend. The actual adjustment of the stream filter can be performed automatically or manually and the solution is not limited to either of these options. The stream analysis may then continue by returning to action 500 again using the adjusted filter.

In a further action 508, the trend analyzer evaluates a trigger condition to determine whether the detected trend fulfils the trigger condition, e.g. in the manner described above for action 3:5. The trend implies a change over time of at least one feature and it is thus checked if that change exceeds a prescribed limit. If not, the process may return to action 500 for further stream analysis by the stream analyzer. If it is determined in action 508 that the change of the at least one feature exceeds the prescribed limit, the trend analyzer requests a deep analysis to find a cause for the detected trend, in an action 510.

The next action 512 illustrates that the requested deep analysis of one or more batches of collected data of a client segment is obtained which has been executed by the batch analyzer. The deep analysis of the data batch(es) may be done e.g. In the manner described above for action 3:8. Further, the batch analyzer may also adjust the stream filter 310, in an optional action 514, based on the outcome of the deep analysis. After such an adjustment of the stream filter, the stream analysis may continue, using the adjusted filter, by returning to action 500 and repeating the subsequent actions. When the deep analysis is deemed to be finished, e.g. after adjustment of the filter and further analysis of data by the stream analyzer and the batch analyzer in an iterative manner stabilizing the outcome from the deep analysis, a final result of the analysis is provided to the result consumer, in an action 516.

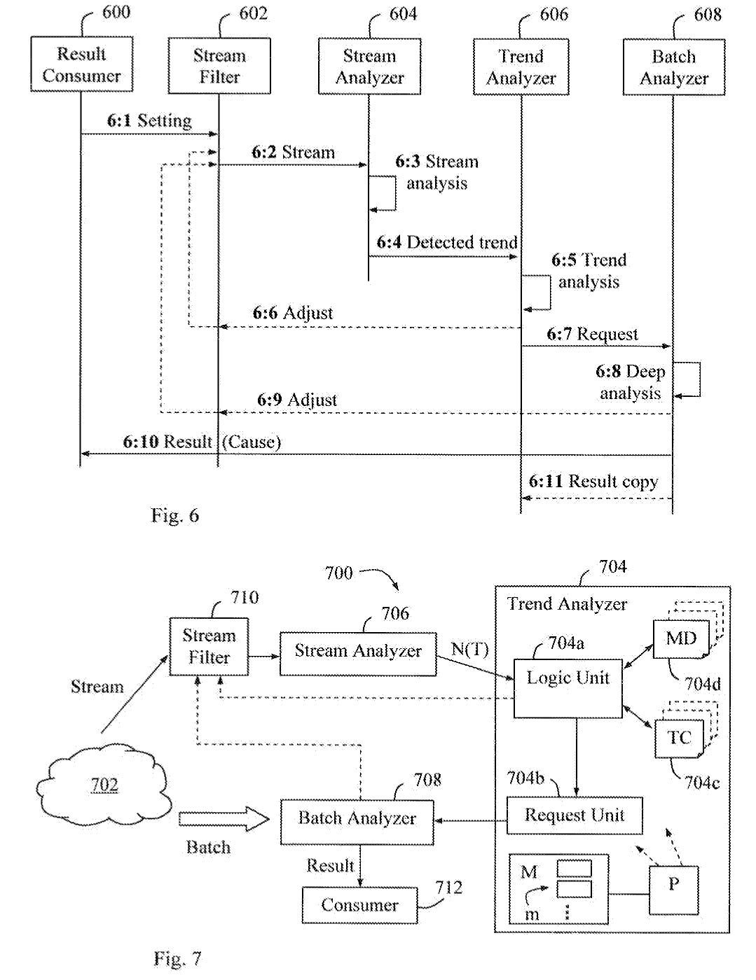

Another example of how the solution is used in practice, will now be described with reference to the signalling diagram FIG. 6. This procedure involves a result consumer 600 and a data analyzing system comprising a stream filter 602, a stream analyzer 604, a trend analyzer 606, and a batch analyzer 608. It should be noted that it is not necessary to always execute the actions in FIG. 6 strictly in the shown order and some variations and repetitions may be employed, e.g. as indicated below.

A first shown action 6:1 illustrates that the result consumer 600 sets the stream filter 602 to an initial setting to extract data related to a segment of clients which is of interest to the result consumer 600. The stream filter 602 will be applied to the client related data before the stream analysis for extracting data related to a limited set of clients. Alternatively, the stream filter 602 may have been initially configured to extract data related to a default set of clients.

A next action 6:2 illustrates that the data stream coming from filter 602 is received by the stream analyzer 604 which duly performs the stream analysis in an action 6:3, basically corresponding to action 3:3 above, possibly after some suitable stream processing as in action 3:2 above. Once the stream analyzer 604 detects a trend reflecting a change over time of at least one feature related to the client segment and derived from the client related data in the received stream, the stream analyzer 604 sends a notification of the detected trend to the trend analyzer 606, in an action 6:4, basically corresponding to action 3:4 above.

In response thereto, the trend analyzer 606 analyzes the detected trend of the client segment, in an action 6:5, to determine whether a deep analysis is warranted for the client segment or not by evaluating a trigger condition, e.g. relative a predefined model as described above, basically corresponding to action 3:5 above. In an optional action 6:6, the trend analyzer 606 may also adjust the stream filter 602 based on the outcome of the analysis of the trend to refine the client segment, basically corresponding to action 3:5a above. If the filter is adjusted, the process may return to action 6:2, as indicated by a dashed arrow from action 6:6.

When the trend analyzer 606 has determined in action 6:5 that the trigger condition is fulfilled by the trend, a request for a deep analysis is sent to the batch analyzer 608, in an action 6:7, to find a cause for the trend by means of batch based analysis of the client related data pertaining to the client segment. The batch analyzer 608 then duly performs the requested deep analysis of one or more batches of collected data of the client segment, in an action 6:8. The batch analyzer 608 may also adjust the stream filter 602 based on the outcome of the deep analysis, in an optional action 6:9, to further refine the client segment, basically corresponding to action 3:8a above. If the fitter is adjusted in this way, the process may return to action 6:2, as indicated by another dashed arrow from action 6:9.

Finally, when the deep analysis of action 6:8 is finished, the batch analyzer 608 provides a final result of the analysis, indicating the cause for the to detected trend, to the result consumer 600, in an action 6:10. The batch analyzer 608 may also send a copy of the deep analysis result to the trend analyzer 606, in an optional action 6:11, e.g. to enable the trend analyzer 606 to update its trigger conditions and/or predefined models used for evaluating trends. This could be made in an iterative manner such that the process may start by the batch analyzer 608 to filter out a segment of influential clients, e.g. by using Social Network Analysis algorithms on the data batch, which is however somewhat outside the scope of this solution.

A detailed but non-limiting example of how a trend analyzer in a data analyzing system can be configured to accomplish the above-described solution, is illustrated by the block diagram in FIG. 7. The data analyzing system 700 is configured to perform analysis of client related data obtained from a communication network 702, e.g. according to the procedures described above for any of FIGS. 3-6. The trend analyzer 704 comprises a logic unit 704a adapted to analyze a trend “T” of a client segment detected by means of a data stream analysis of the client related data, as performed by and received from a stream analyzer 706. The trend reflects a change over time of at least one feature related to the client segment and derived from the client related data. The logic unit 704a is also adapted to determine if the trend fulfils a trigger condition “TC” which has been predefined in the trend analyzer 704.

The trend analyzer 704 further comprises a request unit 704b adapted to request a deep analysis when the trend fulfils the trigger condition TC, to find a cause for the trend by means of batch based analysis of the client related data pertaining to the client segment, which is executed by a batch analyzer 708. When the requested deep analysis has been completed, the batch analyzer 708 is able to provide a result of the requested deep analysis indicating the cause to a result consumer 712.

It should be noted that FIG. 7 merely illustrates various functional units or entities in the data analyzing system 700 and the trend analyzer 704 in a logical sense, although the skilled person is able to implement these functions in practice using suitable software and hardware means. Thus, this aspect of the solution is generally not limited to the shown structures of the trend analyzer 704, and the functional units 704a-b may be configured to operate according to the features described in this disclosure, e.g. for any of FIGS. 3-6, where appropriate.

The functional units 704a-b described above can be implemented in the trend analyzer 704 by means of program modules of a respective computer program comprising code means which, when run by processors “P” causes the trend analyzer 704 to perform the above-described actions. Each processor P may comprise a single Central Processing Unit (CPU), or could comprise two or more processing units. For example, each processor P may include general purpose microprocessors, instruction set processors and/or related chips sets and/or special purpose microprocessors such as Application Specific Integrated Circuits (ASICs). Each processor P may also comprise a storage for caching purposes.

Each computer program may be carried by a computer program product “M” in the trend analyzer 704 in the form of a memory having a computer readable medium and being connected to the processor P. Each computer program product M or memory thus comprises a computer readable medium on which the computer program is stored e.g. in the form of computer program modules “m”. For example, the memory M may be a flash memory, a Random-Access Memory (RAM), a Read-Only Memory (ROM) or an Electrically Erasable Programmable ROM (EEPROM), and the program modules m could in alternative embodiments be distributed on different computer program products in the form of memories within the trend analyzer 704.

The above sensor observation system 400 and its functional units 704a-b may be configured or adapted to operate according to various optional embodiments. In one possible embodiment, a stream filter 710 is applied to the client related data for the data stream analysis for extracting data related to a limited set of clients, and the logic unit 704a is further adapted to adjust the stream filter to refine the client segment, based on the outcome from the analyzing of the trend, such that data related to the refined client segment is extracted by the stream filter. In another possible embodiment, the trigger condition dictates that the deep analysis is requested when the change over time of at least one feature exceeds a prescribed limit.

In further possible embodiments, the at least one feature may refer to any of: the amount of executed calls and sessions, the time of day, week or season of executed calls and sessions, the amount of failed calls and sessions, and a measured sensor parameter.

The logic unit 704a may be further adapted to receive a notification “N(T)” of the detected trend T from a stream analyzer 706 performing the stream analysis, and to analyze the trend with respect to the at least one feature according to a predefined model “MD” indicated in the notification N (T). Further, the trend analyzer 704 may hold different predefined trigger conditions 704c and different corresponding predefined models 704d, and the logic unit 704a may be adapted to check if the trigger condition of the indicated model is fulfilled or not with respect to the one or more features of that model.

While the solution has been described with reference to specific exemplary embodiments, the description is generally only intended to illustrate the inventive concept and should not be taken as limiting the scope of the solution. For example, the terms “client”, “trend”, “trend analyzer”, “stream analyzer”, “batch analyzer”, “deep analysis”, “segment”, “trigger condition” and “stream filter” have been used throughout this description, although any other corresponding nodes, functions, and/or parameters could also be used having the features and characteristics described here. The solution is defined by the appended claims.

1. A method in a data analyzing system for performing analysis of client related data obtained from a communication network, the method comprising:
analyzing a trend of a client segment detected by a data stream analysis of the client related data, said trend reflecting a change over time of at least one feature related to said client segment and derived from the client related data,
requesting a deep analysis when the trend fulfils a trigger condition, to find a cause for the trend by batch based analysis of the client related data pertaining to said client segment, and
providing a result of the requested deep analysis indicating said cause, to a result consumer.

2. The method according to claim 1, wherein a stream filter is applied to the client related data before said data stream analysis for extracting data related to a limited set of clients.

3. The method according to claim 2, wherein the stream filter is initially configured to extract data related to a default set of clients.

4. The method according to claim 2, wherein the stream filter is adjusted to refine the client segment, based on the outcome from any of the analyzing of said segment trend and the analyzing of the deep analysis, such that data related to said refined client segment is extracted by the stream filter.

5. The method according to claim 1, wherein the trigger condition dictates that the deep analysis is requested when said change over time of at least one feature exceeds a prescribed limit.

6. The method according to claim 1, wherein the at least one feature refers to any of: amount of executed calls and sessions, time of day, week or season of executed calls and sessions, amount of failed calls and sessions, and a measured sensor parameter.

7. The method according to claim 1, wherein the client related data pertains to any of: subscribers in the communication network, communication devices, and sensors.

8. The method according to claim 1, wherein the result consumer is any of: a network operator, a service provider, and an application for monitoring or controlling a process or an environment.

9. A trend analyzer in a data analyzing system configured to perform analysis of client related data obtained from a communication network, the trend analyzer comprising:
a logic unit adapted to analyze a trend of a client segment detected by a data stream analysis of the client related data, said trend reflecting a change over time of at least one feature related to said client segment and derived from the client related data, and to determine if the trend fulfils a trigger condition, and
a requesting unit adapted to request a deep analysis when the trend fulfils the trigger condition, to find a cause for the trend by batch based analysis of the client related data pertaining to said client segment, such that a result of the requested deep analysis indicating said cause is provided to a result consumer.

10. The trend analyzer according to claim 9, wherein a stream filter is applied to the client related data for said data stream analysis for extracting data related to a limited set of clients, and the logic unit is further adapted to adjust the stream filter to refine the client segment, based on the outcome from the analyzing of said trend, such that data related to said refined client segment is extracted by the stream filter.

11. The trend analyzer according to claim 9, wherein the trigger condition dictates that the deep analysis is requested when said change over time of at least one feature exceeds a prescribed limit.

12. The trend analyzer according to claim 9, wherein the at least one feature refers to any of: amount of executed calls and sessions, time of day, week or season of executed calls and sessions, amount of failed calls and sessions, and a measured sensor parameter.

13. The trend analyzer according to claim 9, wherein the logic unit is further adapted to receive a notification of the detected trend from a stream analyzer performing the stream analysis, and to analyze the trend with respect to said at least one feature according to a predefined model indicated in the notification.

14. The trend analyzer according to claim 13, holding different predefined trigger conditions and different corresponding predefined models, and wherein the logic unit is adapted to check if the trigger condition of the indicated model is fulfilled or not with respect to the one or more features of that model.

15. The trend analyzer according to claim 9, wherein the client related data pertains to any of: subscribers in the communication network, communication devices, and sensors.
